(19) United States
(12) Patent Application Publication
(10) Pub. No.: US 2026/0175422 A1
(43) Pub. Date: Jun. 25, 2026

(54) ROBOT CONTROL METHOD, ROBOT, AND COMPUTER-READABLE STORAGE MEDIUM

(71) Applicant: UBTECH ROBOTICS CORP LTD, Shenzhen (CN)

(72) Inventors: ZEHONG ZHENG, Shenzhen (CN); Chaofeng Chen, Shenzhen (CN); Baiyu Pan, Shenzhen (CN)

(21) Appl. No.: 19/322,441

(22) Filed: Sep. 8, 2025

(30) Foreign Application Priority Data
Dec. 19, 2024 (CN) 202411899035.3

(51) Int. Cl. B25J 9/16; B25J 13/00; G10L 15/02; G10L 15/22

(52) U.S. Cl. CPC B25J 9/1656; B25J 13/003; G10L 15/02; G10L 15/22; G10L 2015/223

(57) ABSTRACT

A robot control method, a robot, and a computer-readable storage medium are provided. The method includes: obtaining a sounding speech clip in a collected continuous speech by performing a speech state recognition on a speech frame sequence of the collected continuous speech; obtaining a speech eigenvector by performing a feature extraction on the sounding speech clip; obtaining an attention eigenvector by performing an attention processing on the speech eigenvector; determining, based on the attention eigenvector, a speech attribute recognition result and a speech content recognition result of the sounding speech clip; and controlling a robot to perform a target behavior matching the speech attribute recognition result and the speech content recognition result. In this manner, the accuracy of speech recognition can be improved through the attention processing to obtain the accurate speech attribute recognition result and speech content recognition result.

### CROSS REFERENCE TO RELATED APPLICATIONS

The present disclosure claims priority to Chinese Patent Application No. 202411899035.3, filed Dec. 19, 2024, which is hereby incorporated by reference herein as if set forth in its entirety.

### TECHNICAL FIELD

The present disclosure relates to robotics technology, and particularly to a robot control method, a robot, and a computer-readable storage medium.

### BACKGROUND

With the development of artificial intelligence technology, robots are becoming more and more widely used in various fields. Robots can learn the needs and preferences of the user through interaction so as to provide more personalized and accurate services. During interaction, it is necessary to accurately recognize speech contents and respond accordingly based on the recognition results.

However, in the related technologies, it usually uses conventional machine learning algorithms to recognize the speech of the user. Due to only the text contents corresponding to the speeches but the emotions and speech events of the user can be recognized, the accuracies of robots to understand the needs of the user are affected, which reduce the interaction capability of the robots.

### BRIEF DESCRIPTION OF DRAWINGS

FIG. 1 is a flow chart of an optional flow of a robot control method according to an embodiment of the present disclosure.

FIG. 2 is a flow chart of an optional flow of determining a sounding speech clip in a continuous speech based on a speech probability of each speech frame according to an embodiment of the present disclosure.

FIG. 3 is a flow chart of obtaining a preprocessed feature by performing a first preprocessing on the sounding speech clip according to an embodiment of the present disclosure.

FIG. 4 is a flow chart of obtaining a preprocessed speech feature by performing a second preprocessing on the preprocessed features according to an embodiment of the present disclosure.

FIG. 5 is a schematic diagram of obtaining an attention eigenvector of the sounding speech clip by performing an attention processing on the speech eigenvector according to an embodiment of the present disclosure.

FIG. 6 is a flow chart of determining a speech attribute recognition result and a speech content recognition result of the sounding speech clip based on the attention eigenvector according to an embodiment of the present disclosure.

FIG. 7 is a schematic diagram of a speech recognition architecture according to an embodiment of the present disclosure.

FIG. 8 is a schematic diagram of the structure of a robot control apparatus according to an embodiment of the present disclosure.

FIG. 9 is a schematic diagram of the structure of an electronic device according to an embodiment of the present disclosure.

### DETAILED DESCRIPTION

In order to make the purpose, technical solutions, and advantages of the present disclosure clearer, it will be further described in detail below regarding the drawings. The described embodiments should not be regarded as limiting the present disclosure. Instead, all other embodiments obtained by those skilled in the art without making creative work are within the protection scope of present disclosure.

In the following descriptions, “some embodiments” are involved, which describe all possible embodiments, but it should be noted that “some embodiments” may also be the same subset or different subsets of all possible embodiments and may be combined with each other where no conflict therebetween.

If similar descriptions like “first” and “second” appear in the present disclosure, it needs to further explain that, in the following descriptions, the involved terms “first”, “second”, “third”, and the like are merely for differentiating similar objects and do not represent a specific order for the objects. It should be noted that the specific order or sequence of “first”, “second”, “third”, and the like may be interchanged under certain conditions so that the embodiments of the present disclosure described herein may be implemented in an order other than those illustrated or described herein.

In the embodiments of the present disclosure, the term “module” or “unit” refers to an entirety of a computer program with predetermined functions or a part of the computer program that works with other related parts to achieve predetermined goals, which may be implemented in whole or in part by using software, hardware (e.g., processing circuits or storage), or a combination thereof. Similarly, a processor (or a plurality of processors or memories) may be used to implement one or more modules or units. In addition, each module or unit may be part of an integral module or unit containing the functions of the module or unit.

Unless otherwise defined, all technical and scientific terms used in the embodiments of present disclosure are the same as commonly understood by those skilled in the art. The terms used in the embodiments of present disclosure are just for describing the embodiments of present disclosure, rather than limiting the present disclosure.

In the embodiments of the present disclosure, a robot is controlled by: obtaining a sounding speech clip in a collected continuous speech by performing a speech state recognition on a speech frame sequence of the collected continuous speech; obtaining a speech eigenvector by performing a feature extraction on the sounding speech clip; obtaining an attention eigenvector by performing an attention processing on the speech eigenvector; determining, based on the attention eigenvector, a speech attribute recognition result and a speech content recognition result of the sounding speech clip; and controlling a robot to perform a target behavior matching the speech attribute recognition result and the speech content recognition result. In this manner, through the speech state recognition, mute or invalid speech clips can be effectively filtered out in the continuous speech to extract only sounding speech clips, thereby reducing interference of useless data. In addition, by introducing the attention mechanism, the speech eigenvector can focus on the part of key feature, thereby improving the expression capability of speech features and improving the accuracy of speech recognition. Furthermore, the speech recognition result includes the speech attribute recognition results and the speech content recognition results for realizing multi-level analysis of speech information, thereby allowing the robot to comprehend the needs of the user more accurately. Still furthermore, by controlling the behavior of the robot according to the speech attribute recognition result and the speech content recognition result, the robot can achieve accurate and personalized target behavior according to the speech input, thereby improving the interaction capability of the robot.

A robot control method provided by the embodiments of present disclosure may be applied to electronic devices such as robots, laptops, tablets, desktop computers, smart home appliances and smart car equipment.

The robot control method provided in the embodiments of the present disclosure will be described in detail below with reference to the drawings.

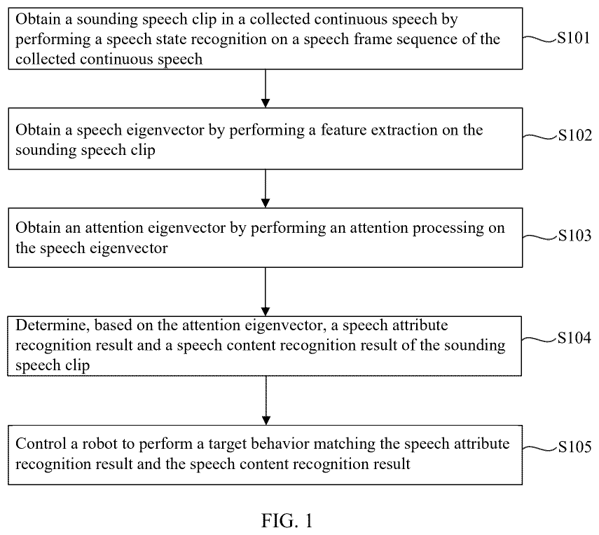

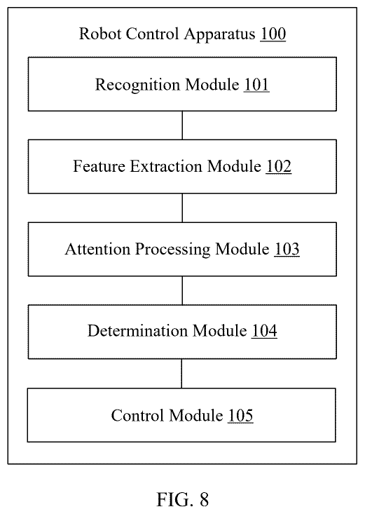

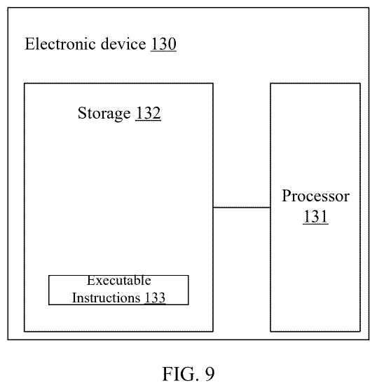

FIG. 1 is a flow chart of an optional flow of a robot control method according to an embodiment of the present disclosure. The following will be exemplified by taking a robot as an example of an electronic device. In this embodiment, the control method is applied to a robot control apparatus (e.g., a controller) as shown in FIG. 8 that is for a robot (e.g., a humanoid robot or a wheeled robot). In other embodiments, the method may be implemented through an electronic device (e.g., a controller) as shown in FIG. 9. As shown in FIG. 1, the control method may include the following steps S101-S105.

S101: obtaining a sounding speech clip in a collected continuous speech by performing a speech state recognition on a speech frame sequence of the collected continuous speech.

The continuous speech refers to natural, smooth, and uninterrupted voice, which may include pauses during speech, background noise, and the like. The continuous speech may have a preset sampling rate. For example, the preset sampling rate is usually 16000 HZ or 8000 HZ. The continuous speech may be collected through one or a plurality of built-in microphone array of the robot. By using a plurality of microphone arrays, it can achieve noise reduction, voice enhancement, and sound source positioning. The robot can adapt to a variety of voice collection environments, including quiet indoor scenes and noisy outdoor scenes. The microphone array may ensure the quality of the continuous speech collected by the robot through noise suppression technology and signal enhancement algorithms.

The speech frame sequence refers to a series of short-term speech frames obtained by dividing continuous speech signals in a fixed time interval. Each speech frame contains a certain number of sampling points. The speech state recognition refers to analyzing the characteristics of the speech frames in the speech frame sequence through an algorithm to determine whether each speech frame is sounding or mute.

The sounding speech clip refers to an audio clip containing speech contents that is extracted from the continuous speech. The sounding speech clip is composed of a plurality of continuous sounding speech frames.

In some embodiments, step S101 may include: first, obtaining a preprocessed speech frame sequence by performing a first preprocessing on the speech frame sequence of the collected continuous speech; then, obtaining a speech probability of each speech frame in the preprocessed speech frame sequence by performing a first feature mapping on the preprocessed speech frame using a pretrained speech event detection model, where the speech probability is for representing a probability of the speech frame having sound; and finally, determining, based on the speech probability of each speech frame, the sounding speech clip in the continuous speech.

The first preprocessing refers to performing a preliminary processing on the speech frame sequence of the collected continuous speech. The first preprocessing may include noise reduction, pre-emphasis, windowing, and the like. In which, the noise reduction refers to reducing environmental noise through noise reduction algorithm. The specific noise reduction algorithm may include spectrum subtraction, Wiener filtering, or noise reduction through deep learning models. The pre-emphasis refers to amplifying the high-frequency components in each speech frame, weakening the influence of low-frequency components on the speech signal, and enhancing the high-frequency characteristics of the speech signal. The windowing refers to applying a window function on each speech frame to reduce the spectrum leakage, where the commonly used windowing functions include Hamming window, rectangular window, and the like.

The pretrained speech event detection model refers to a model that has been trained on a large-scale data set, which is for detecting whether there is a valid sound in each frame of speech signal. The pretrained speech event detection model may be implemented as a traditional machine learning model, such as a hidden Markov model, a support vector machine, or the like. The pretrained speech event detection model may also be implemented as a deep learning model, such as a deep neural network model, a recurrent neural network model, or the like. The valid sound refers to the sounds with practical significance in speech signals, usually including human voices, music, alarm sounds, and other sound signals with specific information or functions.

The first feature mapping refers to extracting the features of each frame of speech signal through the pre-trained speech event detection model to map each frame of speech signal to a speech probability space and output a speech probability of each frame of speech signal, where the speech probability is for representing the probability of having sound in the speech frame.

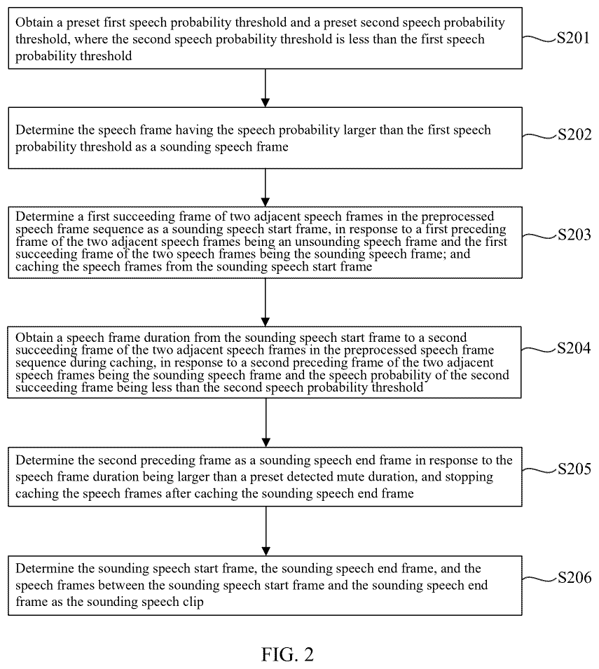

FIG. 2 is a flow chart of an optional flow of determining a sounding speech clip in a continuous speech based on a speech probability of each speech frame according to an embodiment of the present disclosure. As shown in FIG. 2, in some embodiments, the determining, based on the speech probability of each speech frame, the sounding speech clip in the continuous speech may include the following steps S201-S206.

S201: obtaining a preset first speech probability threshold and a preset second speech probability threshold, where the second speech probability threshold is less than the first speech probability threshold.

In some embodiments, the preset first speech probability threshold may be a probability threshold for determining that the speech frame significantly belongs to the sounding speech clip, while the preset second speech probability threshold may be another probability threshold for determining that the speech frame could belong to the sounding speech clip. The second speech probability threshold is less than the first speech probability threshold.

S202: determining the speech frame having the speech probability larger than the first speech probability threshold as a sounding speech frame.

In some embodiments, if the speech probability of speech frame A is larger than the first speech probability threshold, speech frame A is determined as the sounding speech frame.

S203: determining a first succeeding frame of two adjacent speech frames in the preprocessed speech frame sequence as a sounding speech start frame, in response to a first preceding frame of the two adjacent speech frames being an unsounding speech frame and the first succeeding frame of the two speech frames being the sounding speech frame; and caching the speech frames from the sounding speech start frame.

The mute speech frame refers to the speech frame in which there is no sound signal, and the sounding speech start frame refers to the first sounding speech frame after a series of mute speech frames that is for identify the starting point of the sounding speech clip.

In some embodiments, there are adjacent speech frames A and B, where speech frame A is the first preceding frame and speech frame B is the first succeeding frame. In which, speech frame A is the mute speech frame, that is, there is no valid sound in speech frame A, and if speech frame B is determined as the sounding speech frame through the speech probability, speech frame B is determined as the sounding speech start frame, and the speech frames will be cached from speech frame B.

S204: obtaining a speech frame duration from the sounding speech start frame to a second succeeding frame of the two adjacent speech frames in the preprocessed speech frame sequence during caching the speech frames, in response to a second preceding frame of the two adjacent speech frames being the sounding speech frame and the speech probability of the second succeeding frame being less than the second speech probability threshold.

The speech frame duration refers to the duration between having the sounding speech start frame and having the second succeeding frame. The speech frame duration may be calculated as like: the speech frame duration=the number of frames× the duration of a single frame.

In some embodiments, when the buffering starts from sounding speech start frame B, there are adjacent speech frame C and speech frame D, where speech frame C is the second preceding frame and speech frame D is the second succeeding frame. If the speech probability of speech frame D is less than the preset second speech probability threshold, the duration between sounding speech start frame B and speech frame D is determined.

S205: determining the second preceding frame as a sounding speech end frame in response to the speech frame duration being larger than a preset detected mute duration, and stopping caching the speech frames after caching the sounding speech end frame.

The preset detected mute duration is a duration threshold set in advance, which is for determining whether the current speech clip is ended. The sounding speech end frame refers to the last sounding speech frame of the sounding speech clip. The subsequent speech frames after the sounding speech end frame are considered to be the mute speech frames.

In some embodiments, assuming that the preset detected mute duration is 100 ms, and the duration between sounding speech start frame B and speech frame D is calculated as 125 ms, if the speech frame duration is larger than the preset detected mute duration, then speech frame C is determined as the sounding speech end frame, and the caching of the speech frames is stopped after speech frame C is cached.

S206: determining the sounding speech start frame, the sounding speech end frame, and the speech frames between the sounding speech start frame and the sounding speech end frame as the sounding speech clip.

In some embodiments, assuming that there are five speech frames between sounding speech start frame B and sounding speech end frame C, namely speech frames 1-5, sounding speech start frame B, sounding speech end frame C and speech frames 1-5 are spliced into the sounding speech clip.

In some embodiments, in response to the speech frame duration being less than or equal to the preset detected mute duration, the second succeeding frame may be determined as the sounding speech frame to continue to cache the second succeeding frame.

In which, given the preset detected mute duration of 100 ms, and the duration between sounding speech start frame B and speech frame Dis 75 ms, at this time, the speech frame duration is less than the preset detected mute duration, speech frame D is determined as the sounding speech frame, and speech frame D is cached.

In some embodiments, after determining the sounding speech end frame, it may determine that the speech frames after the sounding speech end frame are mute speech frames. Then, the speech frame after the sounding speech end frame may be used as the first preceding frame in recognizing the next sounding speech clip.

S102: obtaining a speech eigenvector by performing a feature extraction on the sounding speech clip.

The feature extraction refers to the process of extracting the core features capable of representing the input data from the input data, and the speech eigenvector refers to the numerical representation of the core information of the speech signal.

In some embodiments, step S102 may include: first, obtaining a preprocessed sound features by performing a second preprocessing on the sounding speech clip; then, obtaining a preprocessed sound eigenvector by performing a feature extraction on the preprocessed sound feature; and then obtaining an encoded eigenvector by obtaining preset index data to perform a data encoding on the index data; and finally obtain the speech eigenvector by performing a first feature splicing on the preprocessed sound eigenvector and the encoded eigenvector.

The second preprocessing refers to performing a preliminary processing on the sounding speech clips, including frame division, windowing, pre-emphasis, or the like.

The index data refers to index labels associated with the sounding speech clip, which may include language category index, speech emotion index, acoustic event detection index, numerical regularization index, and the like. The data encoding refers to converting the index data into fixed formats or numerical representations, where numerical encoding may be performed through single-hot encoding, numerical normalization encoding, or the like. The encoded eigenvector refers to the numerical representation obtained after encoding the index data.

As an example, step S102 may include: first, preprocessing the sounding speech clip to obtain the preprocessed sound feature; then, performing feature extraction on the preprocessed sound feature through a pretrained feature extraction model to obtain the preprocessed sound eigenvector; then, obtaining preset index data related to the sounding speech clip that may include speech category index, speech emotion index, and acoustic event detection index, and performing feature encoding on the index data to obtain the encoded eigenvector; and finally, performing feature splicing on the encoded eigenvector and the preprocessed sound eigenvector to obtain the speech eigenvector. For example, assuming that the encoded eigenvector is [0.2, 0.5, 0.8], and the preprocessed sound eigenvector is [0.4, 0.4, 0.5, 0.3], feature splicing is performed on the encoded eigenvector and the preprocessed sound eigenvector to obtain the speech eigenvector of [0.2, 0.5, 0.8, 0.4, 0.4, 0.5, 0.3].

In some embodiments, the second preprocessing may include a first preprocessing and a second preprocessing, and the obtaining the preprocessed sound features by performing the second preprocessing on the sounding speech clip may include: first, obtaining a preprocessed feature by performing the first preprocessing on the sounding speech clip; then, obtaining the preprocessed sound features by performing the second preprocessing on the preprocessed feature.

In which, the first preprocessing may include operations such as frame division, de-DC, pre-emphasis and windowing, and the second preprocessing may include down-sampling and normalization. The specific processes of the first preprocessing and the second preprocessing are shown below.

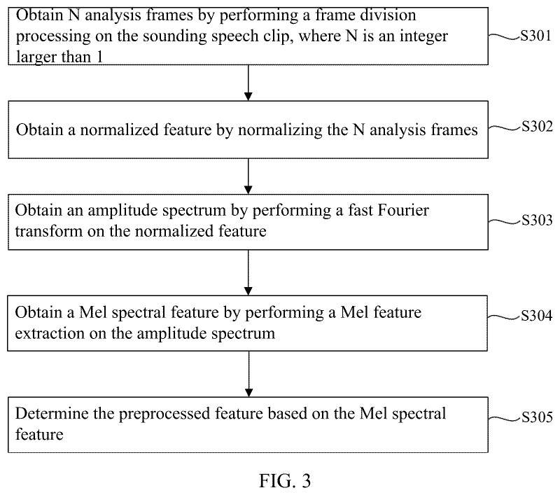

FIG. 3 is a flow chart of obtaining a preprocessed feature by performing a first preprocessing on the sounding speech clip according to an embodiment of the present disclosure. As shown in FIG. 3, in this embodiment, the obtaining the preprocessed feature by performing the first preprocessing on the sounding speech clip may include steps S301-S305:

S301: obtaining N analysis frames by performing a frame division on the sounding speech clip, where N is an integer larger than 1.

The frame division refers to dividing the sounding speech clip according to a fixed time window (i.e., frame length) and a frame shift to form a short-term analysis frame. The frame length refers to the time length covered by each frame of audio data in the frame division, usually in milliseconds, for example, frame length of 25 ms means that each frame contains a 25 ms speech signal, and the frame shift refers to the time interval between the starting positions of two adjacent frames during the frame division.

In some embodiments, step S301 may include: first, sampling the sounding speech clip to obtain a sampling point sequence; then, obtaining a preset frame length and frame shift, such as the frame length of 25 ms (corresponding to 400 sampling points), and the frame shift of 10 ms (corresponding to 160 sampling points); then, intercepting at the start position of the sounding speech according to a preset frame length, such as intercepting 400 sampling points to take as the first analysis frame; and then, moving according to the frame shift, such as moving 160 sampling points and continue to intercept 400 sampling points to take as the second analysis frame, and so on, thereby intercepting the entire sampling point sequence to obtain N analysis frames.

S302: obtaining a normalized feature by normalizing the N analysis frames.

In some embodiments, the normalization includes sequentially performing de-DC, pre-emphasis, windowing, and zero-complement at rear on the analysis frame. In which, the de-DC refers to removing the DC component in the speech signal during processing speech signal, and the DC component refers to the part of the speech signal that does not change with time. The de-DC may be performed using an equation of:

$${x}^{′} ( n ) = x ( n ) - \frac{{\sum }_{n = 0}^{N - 1} x ( n )}{N} \qquad ( Equation 1 )$$

where, n represents the number of the sample point, N represents the total number of the sample points of the analysis frame x; x(n) represents the amplitude of the analysis frame x; and x′(n) represents the amplitude of the analysis frame x after the de-DC.

The pre-emphasis refers to enhancing the high-frequency part in each analysis frame so that the high-frequency part is more significant than the low-frequency part. The pre-emphasis may be performed using an equation of:

$${x}^{″} ( n ) = {x}^{′} ( n ) - α \cdot {x}^{′} ( n - 1 ) \qquad ( Equation 2 )$$

where, α is the pre-emphasis coefficient that is set in advance and usually close to 1 but cannot be equal to 1; x′(n−1) represents the amplitude of the previous frame of the analysis frame x after the de-DC; and x″(n) represents the amplitude of the analysis frame x after the de-DC after performing the pre-emphasis.

The windowing refers to weighting the speech signal after the frame division by applying window function during processing the speech signal. The common window functions include rectangular window, Hanming window, Gaussian window, and the like. Taking Hanming window as an example, the windowing through the Hanming window function may be as an equation of:

$${x}^{′′′} ( n ) = {x}^{″} ( n ) \cdot w ( n ) \qquad ( Equation 3 )$$

where, x′″(n) represents the amplitude of the analysis frame x after the pre-emphasis after applying the Hanming window function; and w(n) is the weight of the Hanming window which may be calculated using an equation of:

$$w ( n ) = 0.54 - 0.46 \cdot cos ( 2 π \frac{n}{N} ) \qquad ( Equation 4 )$$

where, n represents the number of the sample point; and N represents the total number of the sample points in the analysis frame x.

The zero-complement at rear refers complementing zero at the rear of each analysis frame during processing speech signal. Since it is required to perform fast Fourier transform on the analysis frame, and the input of fast Fourier transform needs to be 2″, it requires to perform the zero-complement at rear on each analysis frame so that fast Fourier transform can be performed on the analysis frame. For example, if there are 400 sampling points in the current analysis frame, it requires to complement 112 sampling points at rear.

In some embodiments, after the N analysis frames are respectively normalized, the normalized feature corresponding to each analysis frame is obtained.

S303: obtaining an amplitude spectrum by performing a fast Fourier transform on the normalized feature.

In some embodiments, the fast Fourier transform is a mathematical transform for converting a time domain signal into a frequency domain signal. The amplitude spectrum is the mode of the result of the fast Fourier transform, that is, the intensity of each frequency component in the frequency domain signal, which is for representing the energy distribution of each frequency component in the speech signal. The calculation in step S303 may be performed using an equation of:

$$\vert X ( k ) \vert = \vert FFT \{ {x}^{′′′} ( n ) \} \vert \qquad ( Equation 5 )$$

where, X(k) represents the result of performing the fast Fourier transform on the normalized feature of the analysis frame x; |X(k)| represents the amplitude spectrum; and FFT{x′″(n)} represents performing the fast Fourier transform on the normalized feature of the analysis frame x.

S304: obtaining a Mel spectral feature by performing a Mel feature extraction on the amplitude spectrum.

In some embodiments, the Mel feature extraction is a process of converting a linear frequency scale to a Mel frequency scale that conforms to the perceptual characteristics of the human ear. The Mel spectral feature is the frequency domain representation obtained after performing Mel frequency filtering on the amplitude spectrum. The Mel spectral feature is for representing the energy distribution of the feature signal on Mel frequency. In which, triangular filters are usually used to filter the amplitude spectrum, and each triangular filter covers a certain frequency range. The filtering of the amplitude spectrum through the triangular filters may be performed using an equation of:

$$Mel ( m ) = {\sum }_{k = 0}^{\frac{K}{2} - 1} \{ \vert X ( k ) \vert \cdot min [ \frac{{M}_{M} ( k ) - {M}_{L} ( m )}{{M}_{C} ( m ) - {M}_{L} ( m )} , \frac{{M}_{R} ( m ) - {M}_{M} ( k )}{{M}_{R} ( m ) - {M}_{C} ( m )} ] \} \qquad ( Equation 6 )$$

where, Mel(m) represents the Mel spectral feature; m represents the number of the triangular filter; k represents the number of the frequency point, that is, the sampling point; K represents the total number of the frequency points, that is, the total number of the sample points; M_{L}(m) represents the Mel frequency of the vertex on the left of the triangle filter m; M_{R}(m) represents the Mel frequency of the vertex on the right of the triangle filter m; M_{C}(m) represent the Mel frequency of the vertex above the triangle filter m; and M_{M}(k) represent the Mel frequency corresponding to the frequency point k.

In which, M_{L}(m), M_{C}(m), and M_{R}(m) may be respectively calculated using equations of:

$${M}_{L} ( m ) = {M}_{l} + m \cdot {M}_{Δ} \qquad ( Equation 7 )$$

$${M}_{C} ( m ) = {M}_{l} + ( m + 1 ) \cdot {M}_{Δ} \qquad ( Equation 8 )$$

$${M}_{R} ( m ) = {M}_{l} + ( m + 2 ) \cdot {M}_{Δ} \qquad ( Equation 9 )$$

where, Mₗ represents the lower limit of the total Mel frequency; M_{Δ} represents the interval of the Mel frequency. Mₗ and M_{Δ} may be respectively calculated using equations of:

$${M}_{l} = 1127 \cdot ln ( 1 + \frac{{f}_{l}}{700} ) \qquad ( Equation 10 )$$

$${M}_{Δ} = \frac{{f}_{h} - {f}_{l}}{M + 1} \qquad ( Equation 11 )$$

where, fₗ is the lower limit of the Mel spectrum; fₕ is the upper limit of the Mel spectrum; M is the dimension of the Mel spectral feature (i.e., the total number of the triangular filters) which is a fixed value of 80.

In which, M_{M}(k) may be calculated using an equation of:

$${M}_{M} ( k ) = 1127 \cdot ln ( 1 + \frac{{W}_{k} \cdot k}{700} ) \qquad ( Equation 12 )$$

where, k represents the number of the frequency point; and Wₖ represents the frequency spectrum width of the frequency point k. Wₖ may be calculated using an equation of:

$${W}_{k} = \frac{F}{K} \qquad ( Equation 13 )$$

where, K represents the total number of the frequency point; and F represents the sampling rate of the collected audio.

S305: determining the preprocessed feature based on the Mel spectral feature.

In some embodiments, step S305 may include: calculating the logarithm of the Mel spectral feature to obtain a Mel logarithm spectrum feature; and determining the Mel logarithm spectrum feature as the preprocessed feature. The Mel logarithm spectrum feature may be determined using an equation of:

$$log Mel ( m ) = ln \{ Mel ( m ) \} \qquad ( Equation 14 )$$

where, log Mel(m) represents the Mel logarithmic spectrum feature; and Mel(m) represents the Mel spectrum feature.

It should be noted that the dimensions of the preprocessed feature are {T, M}, where T is the number of the sounding speech frames that is determined after performing the frame division on the sounding speech clip; and M is the dimensions of the Mel spectrum feature, which has a fixed value of 80.

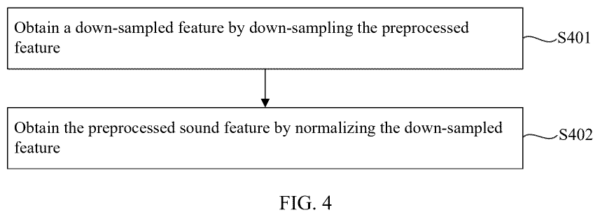

FIG. 4 is a flow chart of obtaining a preprocessed speech feature by performing a second preprocessing on the preprocessed features according to an embodiment of the present disclosure. As shown in FIG. 4, in this embodiment, the obtaining the preprocessed sound features by performing the second preprocessing on the preprocessed feature may include steps S401-S402:

S401: obtaining a down-sampled feature by down-sampling the preprocessed feature.

In some embodiments, the down-sample refers to merging the speech frame sequence obtained after performing the frame division on the sounding speech clip in a certain proportion to reduce the number of the speech frames. The commonly used down-sampling method is low frame rate (LFR) calculation that calculates using an equation of:

$$( Equation 15 )$$

$$lfr ( i , m \& u ) = \{ \begin{matrix}\begin{matrix}C ( 0 , m ) & j < r \\ C ( j - r , m ) & other\end{matrix} \} & \begin{matrix}j = iv , … , iv + u - \\ 1 u \leq ( T + r ) - iv\end{matrix} & \\ \begin{matrix}C ( 0 , m ) & j < r \\ C ( j - r , m ) & other\end{matrix} \} & j = iv , … , T + r - 1 & other \\ C ( T - 1 , m ) & & other\end{matrix}$$

$$i = 0 , 1 , … , ⌈ \frac{T}{u} ⌉ - 1 ; m = 0 , 1 , … , M - 1$$

where, i represents the number of the speech block; j represents the number of the frame; m represents the number of the triangle filter; u represents the number of frames covered by each speech block, which is defaulted to 7; v represents the number of frames that are stepped in each speech block, which is defaulted to 6; r represents the number of the complement frames at head in the first speech block; T represents the number of the sounding speech frames; C( ) represents the speech frame; M represents the total number of triangle filters (the dimensions of the Mel spectrum feature); and ┌ ┐ represents the rounding upwards.

In some embodiments, if the amount of the sound and speech frames is 121, then the dimensions of the preprocessed feature are {111, 80}, u=7, v=6, r=3, p=3. In which, r and p (the amount of complement frames at rear in the last speech block) may be respectively calculated using equations of:

$$r = \frac{u - 1}{2} \qquad ( Equation 16 )$$

$$p = u - [ ( T + r ) - ( ⌈ \frac{T}{u} ⌉ - 1 ) \cdot v ] \qquad ( Equation 17 )$$

At this time, speech block 0 is composed of speech frames [C(0), C(0), C(0), C(0), C(1), C(2), C(3)]; speech block 1 is composed of speech frames [C(3), C(4), C(5), C(6), C(7), C(8), C(9)]; and so on . . . ; speech block

$$( ⌈ \frac{T}{u} ⌉ - 2 )$$

is composed of speech frames [C(111), C(112), C(113), C(114), C(115), C(116), C(117)]; and speech block

$$( ⌈ \frac{T}{u} ⌉ - 1 )$$

is composed of speech frames [C(117), C(118), C(119), C(120), C(120), C(120), C(120)].

S402: obtaining the preprocessed sound feature by normalizing the down-sampled feature.

In some embodiments, during processing the speech signal, the down-sampling feature is usually normalized using cepstral mean and variance normalization (CMVN). The CMVN may be performed based on an equation of:

$$cmvn ( i , m \& u ) = [ lfr ( i , m \& u ) + {mean}_{cmvn} ( m \& u ) ] \cdot {v}_{cmnn} ( m \& u ) \qquad ( Equation 18 )$$

where, mean cₘᵥₙ is the mean; and v_{cmvn} is the variance. The mean and the variance are both determined in advance.

S103: obtaining an attention eigenvector by performing an attention processing on the speech eigenvector.

The attention processing is for capturing key information or key areas in the input feature and to weight according to importance levels. The attention eigenvector refers to the result of the attention processing. In comparison with the speech eigenvector, the attention eigenvector focuses more on the key information, and can better represent speech features.

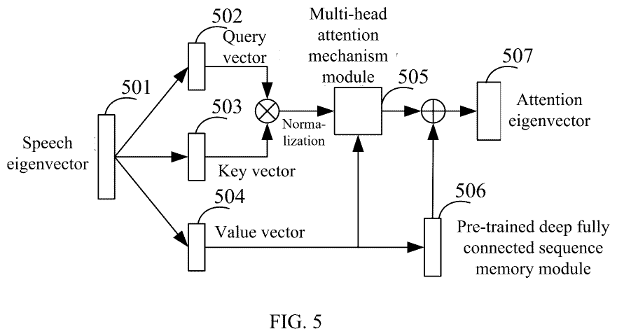

FIG. 5 is a schematic diagram of obtaining an attention eigenvector of the sounding speech clip by performing an attention processing on the speech eigenvector according to an embodiment of the present disclosure. As shown in FIG. 5, in some embodiments, step S103 may include: first, performing a linear mapping on speech eigenvector 501 to obtain query vector 502, key vector 503 and value vector 504; performing a dot product operation on query vector 502 and key vector 503 to obtain a similarity score; normalizing the similarity score to obtain an attention mechanism weight; weighting and summing value vector 504 through the attention mechanism weight to obtain a weighted eigenvector; inputting value vector 504 to pre-trained deep fully connected sequence memory module 506 to obtain a time series eigenvector; inputting the weighted eigenvector to multi-head attention mechanism module 505 to obtain a multi-head attention eigenvector; and performing a feature splicing on the time series eigenvector and the multi-head attention eigenvector to obtain attention eigenvector 507 of the sounding speech clip.

In which, the linear mapping refers to performing linear transformation on the input feature through a preset weight matrix to convert the input feature into a query vector, a key vector, and a value vector. In which, the query vector represents the requirement or query condition for specific information, which is for estimating which parts of the input feature need to be paid attention to; the key vector represents the information label or index of each part of the input feature, and the key vector is for helping the attention mechanism to find relevant content by matching the query vector; and the value vector represents the information actually carried in the input feature.

The similarity score is the numerical values for estimating the relationship or similarity between two vectors, which is usually obtained by performing a dot product operation through the querying vector and the key vector. The dot product operation may be performed using an equation of:

$$score = Q \cdot {K}^{T} \qquad ( Equation 19 )$$

where, score represents the similarity score; Q represents the query vector; K represents the key vector; and T represents a matrix transposition.

The pre-trained deep fully connected sequence memory module refers to a pre-trained network module for extracting time series features. The deep fully connected sequence memory module is for further mining the time series information of the speech feature to capture the pattern of the speech feature changing over time.

The multi-head attention mechanism module is a deep learning computing module that aims to process the input data in parallel through multiple attention heads, which extract different feature relationships from multiple feature subspaces, thereby capturing richer feature representations.

S104: determining, based on the attention eigenvector, a speech attribute recognition result and a speech content recognition result of the sounding speech clip.

The speech attribute recognition result may include a language category label, a speech emotion label, an acoustic event label, a numerical regularization label, and the like. In which, the language category label refers to the language type corresponding to the sounding speech clip, which may include Chinese, English, Cantonese, or the like. The speech emotion label refers to the current emotional type of the user, which may include happiness, anger, sadness, or the like. The acoustic event label refers to what the user is doing, such as singing, crying, or roaring. The numerical regularization label refers to whether to convert the Chinese numbers in the speech content recognition result into Arabic numerals.

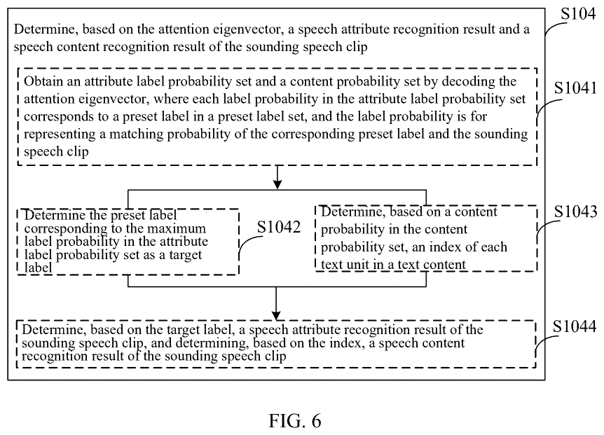

FIG. 6 is a flow chart of determining a speech attribute recognition result and a speech content recognition result of the sounding speech clip based on the attention eigenvector according to an embodiment of the present disclosure. As shown in FIG. 6, in some embodiments, step 104 may include the following steps 1041-1044.

S1041: obtaining an attribute label probability set and a content probability set by decoding the attention eigenvector, where each label probability in the attribute label probability set corresponds to a preset label in a preset label set, and the label probability is for representing a matching probability of the corresponding preset label and the sounding speech clip.

In some embodiments, decoding refers to the process of converting complex, high-dimensional eigenvector to a specific probability. The decoding may usually be realized through a fully connected layer and a nonlinear activation function. The attribute label probability set contains multiple sets of attribute label probabilities. Each label probability in the attribute label probability set corresponds to a preset label in the preset label set. The content probability set refers to a set of probabilities corresponding to a label representing speech and semantic contents. The label probability is for representing the probability that the preset label in the corresponding preset label set matches the sounding speech clip.

The preset label set contains multiple sets of preset labels. The preset label set may include a language category label group, a speech emotion label group, an acoustic event label group, and a numerical regularization label group.

S1042: determining the preset label corresponding to the maximum label probability in the attribute label probability set as a target label.

In some embodiments, assuming that the attribute label probability set contains four sets of attribute label probabilities corresponding to the language category label group, the speech emotion label group, the acoustic event label group, and the numerical regularization label group, each set of attribute label probabilities are traversed respectively to determine the preset label corresponding to the maximum label probability in each set of attribute label probabilities as the target label. For example, if the preset label corresponding to the maximum label probability in the language category label group is 24884; the preset label corresponding to the maximum label probability in the speech emotion label group is 25004; the preset label corresponding to the maximum label probability in the acoustic event label group is 24993; and the preset label corresponding to the maximum label probability in the numerical regularization label group is 25017, labels 24884, 25004, 24993 and 25017 are taken as the target labels.

S1043: determining, based on a content probability in the content probability set, an index of each text unit in a text content.

In some embodiments, the content probability set may contain multiple sets of content probabilities, and each set of content probabilities is traversed to obtain the maximum probability in each set of the content probabilities to use as an index of each text unit. For example, regarding text unit 1, the first set of content probabilities is traversed to obtain index 12226 corresponding to the maximum probability to use as the index of text unit 1.

S1044: determining, based on the target label, a speech attribute recognition result of the sounding speech clip, and determining, based on the index, a speech content recognition result of the sounding speech clip.

In some embodiments, the speech attribute recognition results of the sounding speech clip may be determined by matching in the preset label set according to the target label. For example, target label 24884 corresponds to “Chinese” in the language category label group; target label 25004 corresponds to “happy” in the speech emotion label group; target label 24993 corresponds to “speech” in the acoustic event label group; and target label 25017 corresponds to “no conversion” in the numerical regularization label group. At the same time, the matching is performed in a preset text unit list according to the index to obtain the speech content recognition result like: index 12226 corresponds to the text unit “hi”.

S105: controlling a robot to perform a target behavior matching the speech attribute recognition result and the speech content recognition result.

In some embodiments, if the language category attribute in the speech attribute recognition result is Chinese, other language types are discarded to output the synthesized speech in Chinese.

When the speech emotional attributes in the speech attribute recognition result is determined, a determined emotion label is inserted into prompt information of the pre-trained speech synthesis model. Emotional parameter adjustment is performed on the speech generated by the speech synthesis model through the prompt information to get “happy”, “sad” or the like so that the robot performs speech synthesize through the corresponding emotional parameter.

When the acoustic event attributes in the speech attribute recognition result is determined, a corresponding reply may be made in a direct manner, for example, if the acoustic event attribute is “sing”, the robot will answer “You sing really nicely”; and if the acoustic event attribute is “cry”, the robot will answer “Don't cry. Let's talk.”

When the speech content recognition result is determined, it is inputted into a pre-trained command recognition model to determine the command corresponding to the speech content recognition result. For example, if the speech content recognition result corresponds to an action command like “Get an apple for me”, the robot will enact the movement center to control the robotic arm to grab the apple; and if the speech content recognition result corresponds to a walking command like “Take me to the office”, the robot will enact the navigation system to walk to the designated position according to a generated route.

The robot control method provided by the embodiments of present disclosure may be widely used in a variety of scenarios such as smart home, medical care and accompanying, and human-machine collaboration. In smart home scenario, the robot may be a sweeping robot. The user may control the sweeping robot to perform corresponding operations through voice commands like “sweep the kitchen”. After collecting voice data, the sweeping robot recognizes the voice data to move to the kitchen according to the recognition result so as to clean the kitchen. In medical care and accompanying scenario, the robot may be a smart accompanying robot which can communicate with the elderly. For example, if the elderly say “How is the weather today?”, the smart accompanying robot will collect voice data for recognition, and obtain the weather information of the day based on the recognition results so as to output the weather information in voice. In the human-machine collaboration scenario, the robot may be an industrial robot. The worker may control the industrial robot to perform corresponding operations through voice commands like “Hand me the wrench”. After collecting voice data, the industrial robot will recognize the voice data to enable the robotic arm to pick up the wrench according to the speech recognition result.

In the robot control method provided by the embodiments of present disclosure, through the speech state recognition, mute or invalid speech clips can be effectively filtered out in the continuous speech to extract only sounding speech clips, thereby reducing interference of useless data. In addition, by introducing the attention mechanism, the speech eigenvector can focus on the part of key feature, thereby improving the expression capability of speech features and improving the accuracy of speech recognition. Furthermore, the speech recognition result includes the speech attribute recognition results and the speech content recognition results for realizing multi-level analysis of speech information, thereby allowing the robot to comprehend the needs of the user more accurately. Still furthermore, by controlling the behavior of the robot according to the speech attribute recognition result and the speech content recognition result, the robot can achieve accurate and personalized target behavior according to the speech input, thereby improving the interaction capability of the robot.

As below, exemplary applications of the robot control method provided by the embodiments of the present disclosure in a practical application scenario will be described.

Intelligent robots refer to the robots that integrate thinking, perception and action in compatible and intelligent manners, which not only have human-computer interaction and natural language capabilities, but can also interact with the environment and objects in real time through perception, cognition, decision making to assist the user in completing corresponding decision-making and action tasks.

The user first submits a command to the robot through voice so that it obtains the corresponding text (i.e., the above-mentioned speech content recognition result) through voice recognition to analyze the meaning of the text through a large language model, and then the robot decides to make ordinary Q&A, route navigation, task planning, or the like to perform corresponding broadcast or action.

In order to improve the interaction capability of the robot, the speech recognition needs to have the following capabilities:

1) High-precision recognition; 2) Multilingual recognition so that one model can automatically identify multiple languages; 3) High-speed reasoning so that the inference for audio recognition takes very few time; 4) Emotion recognition to identify emotion and feeling contained in voice; and 5) Event detection that supports detection of various sound events such as music, applause, and laughter.

The robot control method provided by the embodiments of present disclosure may be divided into two parts as follows:

### 1. Speech Clipation:

1) Perform pre-emphasis, frame division, and windowing on the continuous input audio (the continuous speech collected above) to obtain the pre-processed speech frame sequence.

2) Load the onnx model of SileroVAD (the above-mentioned pre-trained speech event detection model), and input the preprocessed speech frame sequence to the onnx model of SileroVAD. The input nodes of the onnx model include the input (input), sr, h, c. In which, sr is the audio sampling rate; the input dimension { } supports 16000 or 8000; h is the intermediate state amount 1, the input dimension {2, batchSize, 64}, and the initial default is an all-zero matrix; C is the intermediate state amount 2, the input dimension {2, batchSize, 64}, and the initial default is an all-zero matrix; batchSize is default as 1 which represents single-channel processing, and may also be set to be larger than 1 which represents multi-channel simultaneous processing.

3) Inference through the onnx model, where the output nodes include output, hn, and cn. In which, output is the output result, the output dimension {batchSize, 1}, and the speech probability is obtained; hn is the output of the intermediate state amount 1, the output dimension {2, batchSize,64}, which is used as the input of the h node of the next frame; cn is the output of the intermediate state amount 2, the output dimension {2, batchSize,64}, which is used as the input of the c node of the next frame.

4) Determine the sounding speech clip based on the speech probability. Regarding the specific determination method, refer to steps S201-S206.

### 2. Voice Recognition:

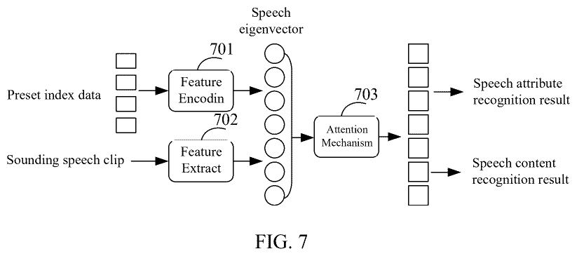

FIG. 7 is a schematic diagram of a speech recognition architecture according to an embodiment of the present disclosure. As shown in FIG. 7, in the peech recognition architecture, feature encoding 701 is performed on preset index data to obtain feature encoding data; feature extract 702 is performed on the sounding speech clip to obtain the preprocessed sound eigenvector; then feature splicing is performed on the preprocessed sound eigenvector and the encoded eigenvector to obtain the speech eigenvector; and then, the speech eigenvector is inputted to attention mechanism 703 for attention processing to obtain the final speech attribute recognition result and speech content recognition result. Regarding the specific speech recognition process, refer to steps S102-S104.

The robot control method provided by the embodiments of present disclosure can improve the speech recognition process, functions such as multilingual recognition, language switching, speech emotion recognition, acoustic event detection, and the like are added, so that the robot can make more perfect answers, behave in more natural, real, and emotional manners, thereby greatly improving interaction capability of the robot.

FIG. 8 is a schematic diagram of the structure of a robot control apparatus 100 according to an embodiment of the present disclosure. As shown in IG. 8, the robot control apparatus 100 is based on the robot control method described in the above-mentioned embodiment. The robot control apparatus 100 may be an apparatus within an electronic device (e.g., a robot), which may be implemented in software in the form of program, plug-in, or the like, and includes the following software modules: a recognition module 101, a feature extraction module 102, an attention processing module 103, a determination module 104, and a control module 105. These modules are logical, so any combination or further split may be performed according to the implemented functions.

In which, the recognition module 101 is configured to obtain a sounding speech clip in a collected continuous speech by performing a speech state recognition on a speech frame sequence of the collected continuous speech; the feature extraction module 102 is configured to obtain a speech eigenvector by performing a feature extraction on the sounding speech clip; the attention processing module 103 is configured to obtain an attention eigenvector by performing an attention processing on the speech eigenvector; the determination module 104 is configured to determine, based on the attention eigenvector, a speech attribute recognition result and a speech content recognition result of the sounding speech clip; and the control module configured 105 is to control a robot to perform a target behavior matching the speech attribute recognition result and the speech content recognition result.

In some embodiments, the recognition module 101 is further configured to obtain a preprocessed speech frame sequence by performing a first preprocessing on the speech frame sequence of the collected continuous speech; obtain a speech probability of each speech frame in the preprocessed speech frame sequence by performing a first feature mapping on the preprocessed speech frame using a pretrained speech event detection model, where the speech probability is for representing a probability of the speech frame having sound; and determine, based on the speech probability of each speech frame, the sounding speech clip in the continuous speech.

In some embodiments, the recognition module 101 is further configured to obtain a preset first speech probability threshold and a preset second speech probability threshold, where the second speech probability threshold is less than the first speech probability threshold; determine the speech frame having the speech probability larger than the first speech probability threshold as a sounding speech frame; determine a first succeeding frame of two adjacent speech frames in the preprocessed speech frame sequence as a sounding speech start frame, in response to a first preceding frame of the two adjacent speech frames being an unsounding speech frame and the first succeeding frame of the two speech frames being the sounding speech frame; and caching the speech frames from the sounding speech start frame; obtain a speech frame duration from the sounding speech start frame to a second succeeding frame of the two adjacent speech frames in the preprocessed speech frame sequence during caching the speech frames, in response to a second preceding frame of the two adjacent speech frames being the sounding speech frame and the speech probability of the second succeeding frame being less than the second speech probability threshold; determine the second preceding frame as a sounding speech end frame in response to the speech frame duration being larger than a preset detected mute duration, and stopping caching the speech frames after caching the sounding speech end frame; and determine the sounding speech start frame, the sounding speech end frame, and the speech frames between the sounding speech start frame and the sounding speech end frame as the sounding speech clip.

In some embodiments, the recognition module 101 is further configured to determine the second succeeding frame as the sounding speech frame in response to the speech frame duration being less than or equal to the preset detection mute time, and continuing to cache the second succeeding frame.

In some embodiments, the feature extraction module 102 is further configured to obtain a preprocessed sound features by performing a second preprocessing on the sounding speech clip; obtain a preprocessed sound eigenvector by performing a feature extraction on the preprocessed sound feature; obtain an encoded eigenvector by obtaining preset index data to perform a data encoding on the index data; and obtain the speech eigenvector by performing a first feature splicing on the preprocessed sound eigenvector and the encoded eigenvector.

In some embodiments, the second preprocessing includes a first preprocessing and a second preprocessing, and the feature extraction module 102 is further configured to: obtain a preprocessed feature by performing the first preprocessing on the sounding speech clip; and obtain the preprocessed sound features by performing the second preprocessing on the preprocessed feature.

In some embodiments, the feature extraction module 102 is further configured to obtain N analysis frames by performing a frame division on the sounding speech clip, where N is an integer larger than 1; obtain a normalized feature by normalizing the N analysis frames; obtain an amplitude spectrum by performing a fast Fourier transform on the normalized feature; obtain a Mel spectral feature by performing a Mel feature extraction on the amplitude spectrum; and determine the preprocessed feature based on the Mel spectral feature.

In some embodiments, the feature extraction module 102 is further configured to: obtain a down-sampled feature by down-sampling the preprocessed feature; and obtain the preprocessed sound feature by normalizing the down-sampled feature.

In some embodiments, the determination module 104 is further configured to: obtain an attribute label probability set and a content probability set by decoding the attention eigenvector, where each label probability in the attribute label probability set corresponds to a preset label in a preset label set, and the label probability is for representing a matching probability of the corresponding preset label and the sounding speech clip; determine the preset label corresponding to the maximum label probability in the attribute label probability set as a target label; determine, based on a content probability in the content probability set, an index of each text unit in a text content; and determine, based on the target label, a speech attribute recognition result of the sounding speech clip, and determining, based on the index, a speech content recognition result of the sounding speech clip.

It should be noted that the description of the apparatus of this embodiment is similar to that of the above-mentioned method embodiment and has beneficial effects similar to that of the method embodiment, which will not be described herein. For the technical details not disclosed in this embodiment, please refer to the description of the method embodiments.

FIG. 9 is a schematic diagram of the structure of an electronic device 130 according to an embodiment of the present disclosure. As shown in IG. 9, the in this embodiment, the electronic device 130 may be a robot. The electronic device 130 includes at least one processor 131 (only one is shown in FIG. 9), a storage 132, and computer executable instructions 133 stored in the storage 132 and executed on the at least one processor 131, where the processor 131 implements the steps in the robot control method of the above-mentioned method embodiment when executing the computer executable instructions 133.

The electronic device may include but not be limited to the processor 131 and the storage 132. It may be understood by those skilled in the art that FIG. 9 is only an example of the electronic device 130 and does not constitute a limitation on the electronic device 130, and may include more or fewer components than shown in the figure, or combine of some components or different components, for example, it may further include an input/output equipment, a network access equipment, or the like.

The processor 131 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

In some embodiments, the storage 132 may be an internal storage unit of the intelligent mobile device 5, for example, a hard disk or a memory of the intelligent mobile device 5. In other embodiments, the storage 132 may also be an external storage device of the intelligent mobile device 5, for example, a plug-in hard disk, a smart media card (SMC), a secure digital (SD) card, flash card, and the like, which is equipped on the intelligent mobile device 5. Furthermore, the storage 132 may further include both an internal storage unit and an external storage device, of the intelligent mobile device 5. The storage 132 is configured to store xx. The storage 132 may also be used to temporarily store data that has been or will be output.

The embodiments of the present disclosure further provide a computer-readable storage medium storing computer-executable instructions. The above-mentioned robot control method (e.g., the robot control method shown in FIG. 1) is executed by a processor when the processor executes the computer-executable instructions.

The embodiments of the present disclosure further provide a computer program product that includes computer-executable instructions stored in a computer-readable storage medium. A processor of an electronic device reads the computer-executable instructions from the computer-readable storage medium and executes the computer-executable instructions so that the electronic device performs the above-mentioned robot control method.

In some embodiments, the computer-readable storage medium may be a storage such as RAM, ROM, flash memory, magnetic surface memory, optical disk, or CD-ROM, and may also be various equipment including one of the forgoing storages or any combination of them.

In some embodiments, the computer-executable instructions may be implemented in the form of a program, software, software module, script or codes in any form of programming language (including compiled or interpreted languages, or declarative or procedural languages), and may be deployed in any form, including being deployed as a standalone program, a module, a component, a subroutine, or other unit suitable for use in a computing environment.

As an example, the computer-executable instructions may, but do not necessarily correspond to a file in the file system, and may be stored in a part of the file storing other programs or data, for example, in one or more scripts of a Hyper Text Markup Language (HTML) document, or stored in a single file dedicated to the program in question, or a plurality of collaborative files (e.g., files that store one or more modules, subroutines, or code parts).

As an example, the computer-executable instructions may be deployed to execute on one electronic device, or on a plurality of electronic devices located at one location, or a plurality of electronic devices distributed across multiple locations and interconnected over a communication network.

The foregoing are merely the embodiments of the present disclosure and are not intended to limit the scope of the protection of the present disclosure. Any modification, equivalent substitution, improvement, and the like made within the spirit and scope of the present disclosure are included within the scope of the protection of the present disclosure.

What is claimed is:

1. A method for controlling a robot, comprising:
obtaining a sounding speech clip in a collected continuous speech by performing a speech state recognition on a speech frame sequence of the collected continuous speech;
obtaining a speech eigenvector by performing a feature extraction on the sounding speech clip;
obtaining an attention eigenvector by performing an attention processing on the speech eigenvector;
determining, based on the attention eigenvector, a speech attribute recognition result and a speech content recognition result of the sounding speech clip; and
controlling the robot to perform a target behavior matching the speech attribute recognition result and the speech content recognition result.

2. The method of claim 1, wherein obtaining the sounding speech clip in the collected continuous speech by performing the speech state recognition on the speech frame sequence of the collected continuous speech comprises:
obtaining a preprocessed speech frame sequence by performing a first preprocessing on the speech frame sequence of the collected continuous speech;
obtaining a speech probability of each speech frame in the preprocessed speech frame sequence by performing a first feature mapping on the preprocessed speech frame using a pretrained speech event detection model, wherein the speech probability is for representing a probability of the speech frame having sound; and
determining, based on the speech probability of each speech frame, the sounding speech clip in the continuous speech.

3. The method of claim 2, wherein determining, based on the speech probability of each speech frame, the sounding speech clip in the continuous speech comprises:
obtaining a preset first speech probability threshold and a preset second speech probability threshold, wherein the second speech probability threshold is less than the first speech probability threshold;
determining the speech frame having the speech probability larger than the first speech probability threshold as a sounding speech frame;
determining a first succeeding frame of two adjacent speech frames in the preprocessed speech frame sequence as a sounding speech start frame, in response to a first preceding frame of the two adjacent speech frames being an unsounding speech frame and the first succeeding frame of the two speech frames being the sounding speech frame; and caching the speech frames from the sounding speech start frame;
obtaining a speech frame duration from the sounding speech start frame to a second succeeding frame of the two adjacent speech frames in the preprocessed speech frame sequence during caching the speech frames, in response to a second preceding frame of the two adjacent speech frames being the sounding speech frame and the speech probability of the second succeeding frame being less than the second speech probability threshold;
determining the second preceding frame as a sounding speech end frame in response to the speech frame duration being larger than a preset detected mute duration, and stopping caching the speech frames after caching the sounding speech end frame; and
determining the sounding speech start frame, the sounding speech end frame, and the speech frames between the sounding speech start frame and the sounding speech end frame as the sounding speech clip.

4. The method of claim 3, further comprising:
determining the second succeeding frame as the sounding speech frame in response to the speech frame duration being less than or equal to the preset detection mute time, and continuing to cache the second succeeding frame.

5. The method of claim 1, wherein obtaining the speech eigenvector by performing the feature extraction on the sounding speech clip comprises:
obtaining a preprocessed sound features by performing a second preprocessing on the sounding speech clip;
obtaining a preprocessed sound eigenvector by performing a feature extraction on the preprocessed sound feature;
obtaining an encoded eigenvector by obtaining preset index data to perform a data encoding on the index data; and
obtaining the speech eigenvector by performing a first feature splicing on the preprocessed sound eigenvector and the encoded eigenvector.

6. The method of claim 5, wherein the second preprocessing includes a first preprocessing and a second preprocessing; and obtaining the preprocessed sound features by performing the second preprocessing on the sounding speech clip comprises:
obtaining a preprocessed feature by performing the first preprocessing on the sounding speech clip; and
obtaining the preprocessed sound features by performing the second preprocessing on the preprocessed feature.

7. The method of claim 6, wherein obtaining the preprocessed feature by performing the first preprocessing on the sounding speech clip comprises:
obtaining N analysis frames by performing a frame division on the sounding speech clip, wherein Nis an integer larger than 1;
obtaining a normalized feature by normalizing the N analysis frames;
obtaining an amplitude spectrum by performing a fast Fourier transform on the normalized feature;
obtaining a Mel spectral feature by performing a Mel feature extraction on the amplitude spectrum; and
determining the preprocessed feature based on the Mel spectral feature.

8. The method of claim 7, wherein obtaining the preprocessed sound features by performing the second preprocessing on the preprocessed feature comprises:
obtaining a down-sampled feature by down-sampling the preprocessed feature; and
obtaining the preprocessed sound feature by normalizing the down-sampled feature.

9. The method of claim 1, wherein determining, based on the attention eigenvector, a speech attribute recognition result and a speech content recognition result of the sounding speech clip comprises:
obtaining an attribute label probability set and a content probability set by decoding the attention eigenvector, wherein each label probability in the attribute label probability set corresponds to a preset label in a preset label set, and the label probability is for representing a matching probability of the corresponding preset label and the sounding speech clip;
determining the preset label corresponding to the maximum label probability in the attribute label probability set as a target label;
determining, based on a content probability in the content probability set, an index of each text unit in a text content; and
determining, based on the target label, a speech attribute recognition result of the sounding speech clip, and determining, based on the index, a speech content recognition result of the sounding speech clip.

10. A robot, comprising:
a processor;
a memory coupled to the processor; and
one or more computer programs stored in the memory and executable on the processor;
wherein, the one or more computer programs comprise:
instructions for obtaining a sounding speech clip in a collected continuous speech by performing a speech state recognition on a speech frame sequence of the collected continuous speech;
instructions for obtaining a speech eigenvector by performing a feature extraction on the sounding speech clip;
instructions for obtaining an attention eigenvector by performing an attention processing on the speech eigenvector;
instructions for determining, based on the attention eigenvector, a speech attribute recognition result and a speech content recognition result of the sounding speech clip; and
instructions for controlling the robot to perform a target behavior matching the speech attribute recognition result and the speech content recognition result.

11. The robot of claim 10, wherein the instructions for obtaining the sounding speech clip in the collected continuous speech by performing the speech state recognition on the speech frame sequence of the collected continuous speech comprise:
instructions for obtaining a preprocessed speech frame sequence by performing a first preprocessing on the speech frame sequence of the collected continuous speech;
instructions for obtaining a speech probability of each speech frame in the preprocessed speech frame sequence by performing a first feature mapping on the preprocessed speech frame using a pretrained speech event detection model, wherein the speech probability is for representing a probability of the speech frame having sound; and
instructions for determining, based on the speech probability of each speech frame, the sounding speech clip in the continuous speech.

12. The robot of claim 11, wherein the instructions for determining, based on the speech probability of each speech frame, the sounding speech clip in the continuous speech comprise:
instructions for obtaining a preset first speech probability threshold and a preset second speech probability threshold, wherein the second speech probability threshold is less than the first speech probability threshold;
instructions for determining the speech frame having the speech probability larger than the first speech probability threshold as a sounding speech frame;
instructions for determining a first succeeding frame of two adjacent speech frames in the preprocessed speech frame sequence as a sounding speech start frame, in response to a first preceding frame of the two adjacent speech frames being an unsounding speech frame and the first succeeding frame of the two speech frames being the sounding speech frame; and caching the speech frames from the sounding speech start frame;
instructions for obtaining a speech frame duration from the sounding speech start frame to a second succeeding frame of the two adjacent speech frames in the preprocessed speech frame sequence during caching the speech frames, in response to a second preceding frame of the two adjacent speech frames being the sounding speech frame and the speech probability of the second succeeding frame being less than the second speech probability threshold;
instructions for determining the second preceding frame as a sounding speech end frame in response to the speech frame duration being larger than a preset detected mute duration, and stopping caching the speech frames after caching the sounding speech end frame; and
instructions for determining the sounding speech start frame, the sounding speech end frame, and the speech frames between the sounding speech start frame and the sounding speech end frame as the sounding speech clip.

13. The robot of claim 12, wherein the one or more computer programs further comprise:
instructions for determining the second succeeding frame as the sounding speech frame in response to the speech frame duration being less than or equal to the preset detection mute time, and continuing to cache the second succeeding frame.

14. The robot of claim 10, wherein the instructions for obtaining the speech eigenvector by performing the feature extraction on the sounding speech clip comprise:
instructions for obtaining a preprocessed sound features by performing a second preprocessing on the sounding speech clip;
instructions for obtaining a preprocessed sound eigenvector by performing a feature extraction on the preprocessed sound feature;
instructions for obtaining an encoded eigenvector by obtaining preset index data to perform a data encoding on the index data; and
instructions for obtaining the speech eigenvector by performing a first feature splicing on the preprocessed sound eigenvector and the encoded eigenvector.

15. The robot of claim 14, wherein the instructions for the second preprocessing includes a first preprocessing and a second preprocessing; and obtaining the preprocessed sound features by performing the second preprocessing on the sounding speech clip comprise:
instructions for obtaining a preprocessed feature by performing the first preprocessing on the sounding speech clip; and
instructions for obtaining the preprocessed sound features by performing the second preprocessing on the preprocessed feature.

16. The robot of claim 15, wherein the instructions for obtaining the preprocessed feature by performing the first preprocessing on the sounding speech clip comprise:
instructions for obtaining N analysis frames by performing a frame division on the sounding speech clip, wherein N is an integer larger than 1;
instructions for obtaining a normalized feature by normalizing the N analysis frames;
instructions for obtaining an amplitude spectrum by performing a fast Fourier transform on the normalized feature;
instructions for obtaining a Mel spectral feature by performing a Mel feature extraction on the amplitude spectrum; and
instructions for determining the preprocessed feature based on the Mel spectral feature.

17. The robot of claim 16, wherein the instructions for obtaining the preprocessed sound features by performing the second preprocessing on the preprocessed feature comprise:
instructions for obtaining a down-sampled feature by down-sampling the preprocessed feature; and
instructions for obtaining the preprocessed sound feature by normalizing the down-sampled feature.

18. The robot of claim 10, wherein the instructions for determining, based on the attention eigenvector, a speech attribute recognition result and a speech content recognition result of the sounding speech clip comprise:
instructions for obtaining an attribute label probability set and a content probability set by decoding the attention eigenvector, wherein each label probability in the attribute label probability set corresponds to a preset label in a preset label set, and the label probability is for representing a matching probability of the corresponding preset label and the sounding speech clip;
instructions for determining the preset label corresponding to the maximum label probability in the attribute label probability set as a target label;
instructions for determining, based on a content probability in the content probability set, an index of each text unit in a text content; and
instructions for determining, based on the target label, a speech attribute recognition result of the sounding speech clip, and determining, based on the index, a speech content recognition result of the sounding speech clip.

19. A non-transitory computer-readable storage medium for storing one or more computer programs, wherein the one or more computer programs comprise:
instructions for obtaining a sounding speech clip in a collected continuous speech by performing a speech state recognition on a speech frame sequence of the collected continuous speech;
instructions for obtaining a speech eigenvector by performing a feature extraction on the sounding speech clip;
instructions for obtaining an attention eigenvector by performing an attention processing on the speech eigenvector;
instructions for determining, based on the attention eigenvector, a speech attribute recognition result and a speech content recognition result of the sounding speech clip; and
instructions for controlling a robot to perform a target behavior matching the speech attribute recognition result and the speech content recognition result.

20. The storage medium of claim 19, wherein the instructions for obtaining the sounding speech clip in the collected continuous speech by performing the speech state recognition on the speech frame sequence of the collected continuous speech comprise:
instructions for obtaining a preprocessed speech frame sequence by performing a first preprocessing on the speech frame sequence of the collected continuous speech;
instructions for obtaining a speech probability of each speech frame in the preprocessed speech frame sequence by performing a first feature mapping on the preprocessed speech frame using a pretrained speech event detection model, wherein the speech probability is for representing a probability of the speech frame having sound; and
instructions for determining, based on the speech probability of each speech frame, the sounding speech clip in the continuous speech.
